(19) United States
(12) Patent Application Publication
(10) Pub. No.: US 2006/0170650 A1
(43) Pub. Date: Aug. 3, 2006

(54) Method and system for gestural control of an apparatus

(76) Inventor: Stephane Madrange, Saint-Germain En Laye (FR)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/565,869

(22) PCT Filed: Jul. 20, 2004
(86) PCT No.: PCT/EP04/08099

§ 371 Date: Jan. 24, 2006

(30) Foreign Application Priority Data
Jul. 24, 2003 (FR) 0309084

(51) Int. Cl. G09G 5/00

(52) U.S. Cl. 345/156

(57) ABSTRACT

In order to control an apparatus (40), in particular provided with an image display associated with a display screen (41), this control system comprises a control device (1) carried by the user and including means for measuring his movements following at least a first axis (Z), and means for transmitting the movement measurements to a processing device (20) connected to the apparatus to be controlled (40), the processing device comprising means for determining the commands to apply to the apparatus to be controlled as a function of received movement measurements, the controls comprising information about displacement in a plane (X-Y) non-parallel to the first axis (Z), and information about control activation determined as a function of movement measurements along the first axis (Z), transmitted by the control device.

The present invention relates to a method and a device for controlling an apparatus equipped with a display screen such as a microcomputer or a television set, or a projection device.

In particular, but not exclusively, it applies to control of an apparatus through the intermediary of a pointer displayed on a display screen or to the selection of display zones on such a display screen.

In order to displace a pointer on a display screen or to select display zones, systems have been developed such as a mouse, a touch sensitive surface, joystick or tracker ball or also button assemblies. There are also remote controls provided with control keys, communicating with the system controlling the display screen through the intermediary of an infrared, radio or ultrasound link.

Nonetheless, these systems have many limitations related, in particular, to ergonomics.

In fact, most of these systems (mouse, sensitive surface, joystick, tracker ball) have the disadvantage of needing a horizontal surface in which they can be set, and usually have to be close to the apparatus being controlled, so that they are poorly adapted to public presentations.

Systems have also been developed that are able to detect user movements with sensors carried by the user or connected to the apparatus being controlled. Such a system is described for example in the patent U.S. Pat. No. 6,275,214. This system operates a camera connected to the apparatus being controlled and a laser pointer carried by the user, which projects a laser spot on a display screen which is detected by an image analysis system connected to the camera. In order to reproduce the functioning of a mouse and in particular mouse buttons making it possible to introduce, in particular, validation controls of a choice or of a position, the laser pointer comprises control buttons to modify the shape or color of the spot projected onto the screen. This solution has the disadvantage of being relatively costly to apply, because of the use of a camera and a controllable laser pointer able to modify the color or the shape of the spot. Furthermore, in order to be completely portable and mobile, the laser pointer must be equipped with its own energy supply, meaning that its autonomy decreases accordingly as its dimensions are reduced.

Patent U.S. Pat. No. 5,703,623 describes a pointing device including movement sensors according to three axes to detect changes of position and/or orientation, and calculation means coupled with the movement sensors.

Patent U.S. Pat. No. 5,737,360 describes a control device for elements displayed on a screen, this device including a control box ovoid in shape intended to be hand-held and enclosing accelerometers intended to detect certain movement patterns of the hand.

The patent application WO 00/63874 describes a pointing device intended to be hand-held and designed to detect a displacement (an acceleration) in the three dimensions without contact with a surface, and to detect the pressure of the user's hand. This device is designed to be connected by a wire link to a computer, which limits utilization possibilities.

All these devices are bulky and costly to manufacture, and when they do not have a wire link they have limited autonomy.

The aim of the present invention is to overcome these disadvantages. This aim is achieved by providing a remote control method for an apparatus, using a control device carried by the user, and comprising steps of:

measuring the movements of the control device along at least one first axis;

defining the commands to be applied to the apparatus being controlled as a function of movement measurements of the control device, and

applying commands to the apparatus being controlled.

According to the invention, this method includes steps during which the control device transmits the movement measurements and radio-electric signals to a processing device connected to the apparatus being controlled, and the processing device:

receives movement measurements and radio-electric signals from the control device through the intermediary of at least first and second antennas spaced out along a second axis non-parallel to the first axis;

demodulates in synchronous manner with a reference signal, the radio-electric signals received by the first and second antennas respectively, and

defines the commands to be applied to the apparatus being controlled, the commands comprising displacement information along at least the second axis, determined as a function of demodulated signals, and information about control activation defined as a function of the movement measurements along the first axis, received from the control device.

According to a preferred embodiment of the invention, the movement measurements along the first axis, made by the control device, are measurements of the control device acceleration along the first axis, the processing device defining the information about command activation by comparing the acceleration measured with at least one predefined threshold.

According to a preferred embodiment of the invention, the processing device receives the radio-electric signals emitted by the control device through the intermediary of at least one third antenna separated from the first and second antennas along a third axis non-parallel to the first and second axes, and determines displacement information from the control device following the third axis, by measuring the phase shifts between the reference signal and the radio-electric signals received by the processing device through the intermediary of the third antenna.

According to a preferred embodiment of the invention, this method furthermore includes a step of periodic transmission of an activation radio-electric signal to the control device, the steps of measurement and transmission of the control device movement measurements being carried out only after receiving the activation signal.

According to a preferred embodiment of the invention, this method furthermore comprises steps of:

transmitting an activation radio-electric signal to the control device;

doubling the frequency of the activation signal by the control device to obtain a carrier having a frequency twice that of the activation signal;

modulating the carrier to transmit control device movement measurements to the processing device, and

generating the reference signal by the processing device consisting of doubling the frequency of the activation signal.

Alternatively, movement measurements along at least the first axis are transmitted by the control device under the form of light signals.

The invention also concerns a remote control system for an apparatus, the control system comprising a control device carried by the user and communicating with the apparatus to be controlled, the control device comprising means for measuring its movements along at least a first axis.

According to the invention, the control device comprises means for emitting movement measurements and radio-electric signals, the system further comprising a processing device connected to the apparatus to be controlled and to at least the first and second antennas spaced out along a second axis non-parallel to the first axis, and receiving the radio-electric signals emitted by the control device, the processing device including:

means for receiving movement measurements emitted by the control device;

means for demodulating in a synchronous manner with a reference signal, the radio-electric signals received from the control device respectively by the intermediary of the first and second antennas;

means for determining the displacement information along at least the second axis as a function of the measured phase shifts;

means for determining control activation information as a function of movement measurements along the first axis, received from the control device, and

means for determining commands to be applied to the apparatus to be controlled, from control displacement and activation information.

According to a preferred embodiment of the invention, the control device includes means for measuring the acceleration of the control device along the first axis, and for transmitting the acceleration measurements along this axis to the processing device, the processing device including means for comparing acceleration measurements received at a predefined threshold, to determine control activation information.

According to a preferred embodiment of the invention, the processing device comprises at least a third antenna set spaced out from said first and second antennas along a third axis non-parallel to the first and second axes, means for measuring phase shifts between the signals received by the third antenna and the reference signal, and means for determining a displacement of the control device along the third axis, as a function of the phase shifts measured by the phase shift measurement means.

According to a preferred embodiment of the invention, the control device comprises means for transmitting movement measurement signals along at least the first axis by modulation of the radio-electric signals.

According to a preferred embodiment of the invention, the processing device comprises means for periodic transmission of an activation radio-electric signal to the control device, the control device comprising means for detecting reception of the activation signal, means for being at least partially off-line in the absence of detection of an activation signal, and means for activating signal transmission to the processing device for a predefined length of time following reception of the activation signal.

Advantageously, the control device comprises a frequency doubler to which the activation signal is applied for generating a carrier having a frequency twice that of the activation signal, and means for modulating the carrier as a function of movement measurements along at least the first axis, and means for emitting the modulated carrier in the form of radio-electric signals, the processing device comprising a frequency doubler for generating the reference signal from the activation signal.

Alternatively, the control device comprises means for transmitting the movement measurement signals from the control device along at least the first axis in the form of light signals.

According to a preferred embodiment of the invention, the control device comprises a switch for putting it off-line.

According to a preferred embodiment of the invention, the control device has a shape such that it can be attached onto one of the user's fingers.

Preferably, the control device comprises a switch for putting it off-line, set in such a way that it is on-Aine only when it is attached to one of the user's fingers.

Preferred embodiments of the invention will be described below, as non-limiting examples, with reference to the attached drawings in which:

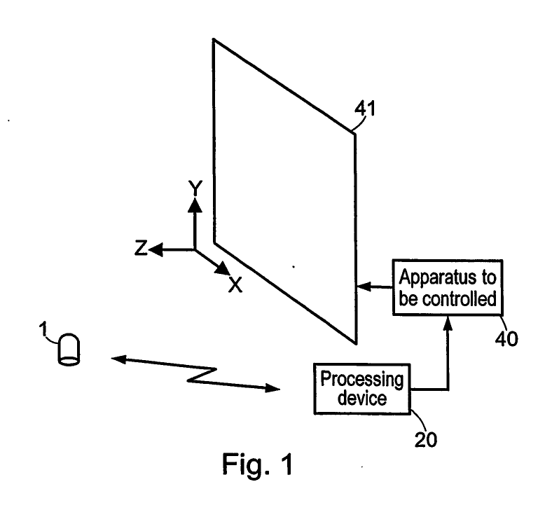

FIG. 1 shows diagrammatically a control system according to the invention;

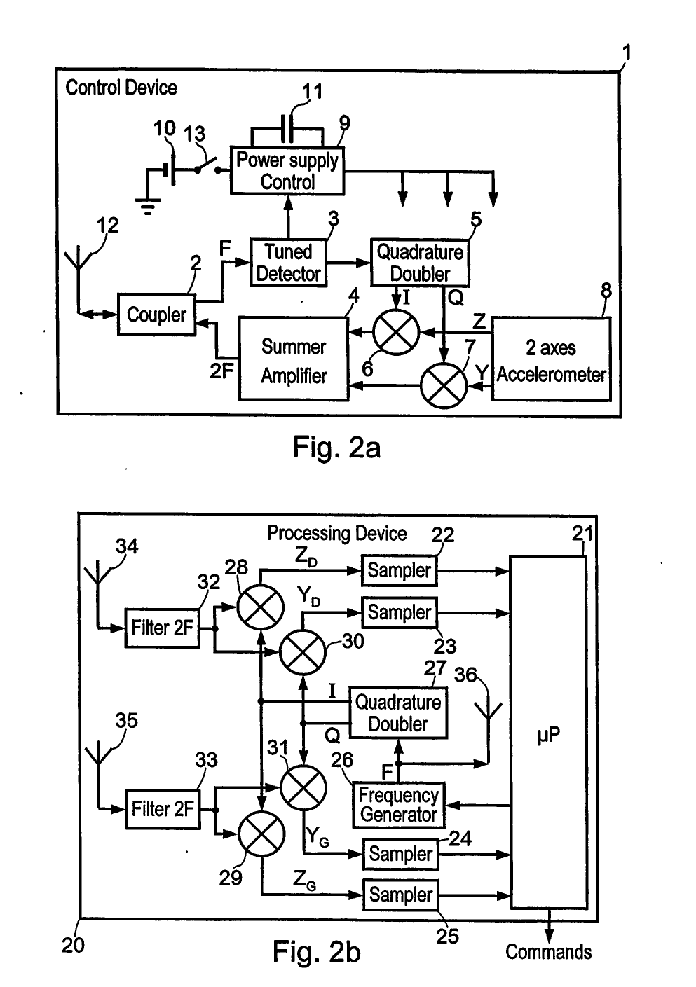

FIGS. 2a and 2b show in more detail a first embodiment respectively of the control device and the processing device of the control system shown in FIG. 1;

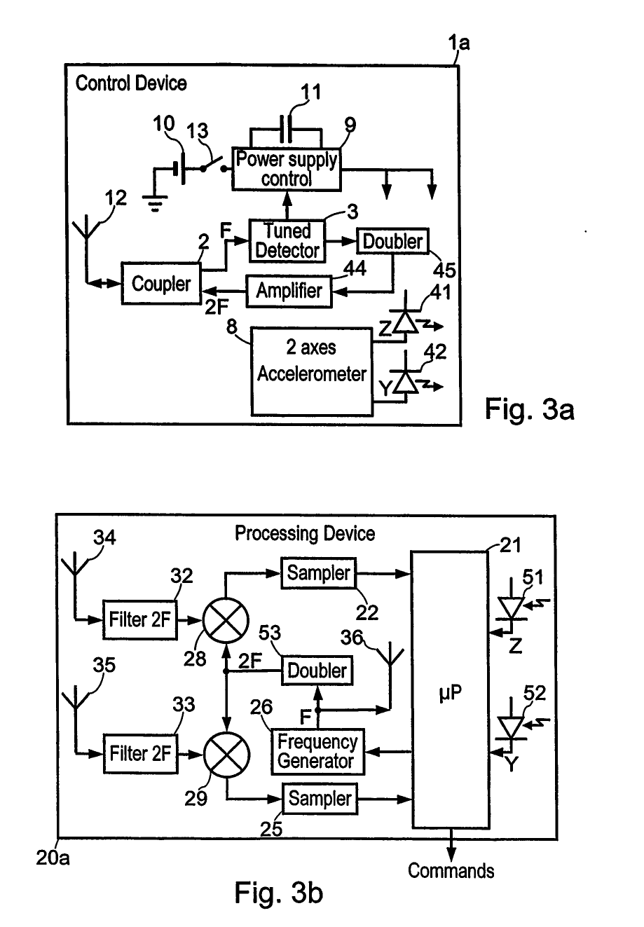

FIGS. 3a and 3b show a second embodiment respectively of the control device and the processing device of the control system shown in FIG. 1;

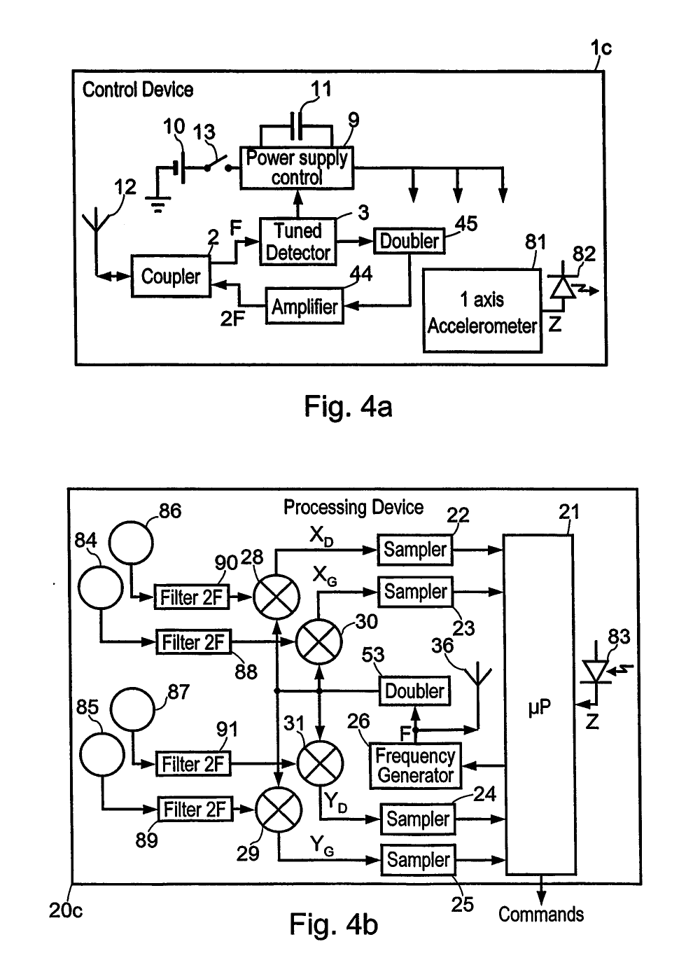

FIGS. 4a and 4b show a third embodiment respectively of the control device and the processing device of the control system shown in FIG. 1.

FIG. 1 shows a control system of an apparatus 40, in particular an apparatus associated with an image display, such as a computer or a television set, provided with a display screen 41 or a video projector. This system comprises a control device 1 intended to be worn by the user and designed to emit movement signals, a processing device 20 designed to receive and process the movement signals emitted by the control device to define controls to apply to the apparatus being controlled 40, the processing device 20 then being connected to the apparatus being controlled.

In FIG. 2a, the control device 1 comprises:

movement sensors 8, such as an accelerometer with two axes, to measure the movements of the control device, applied by the user along two axes, that is a vertical axis Y and a horizontal axis Z perpendicular to the plane of the display screen 41;

a send-receive antenna 12 for receiving an activation signal emitted by the processing device 20 and in response emitting signals providing movement measurements measured by the movement sensors 8;

a directional coupler 2 connected to the antenna 12 to orient the activation signal picked up by the antenna and applied to a first terminal towards a second terminal connected to a detection circuit 3 tuned to the frequency F of the activation signal, and to orient the applied signals to a third terminal towards the first terminal;

a frequency doubler in quadrature 5 connected to the detection circuit 3 and providing, on two outputs respectively, two signals I and Q having a frequency 2F which is twice the frequency F of the activation signal, in phase and in phase quadrature respectively,

two modulators 6, 7 for example of annular type, receiving as input the signals I and Q and the movement values measured by the movement sensors 8 to modulate the signals I and Q with the measured movement values, and

a summing amplifier 4 connected to two modulators 6, 7 designed to add and amplify the modulated signals I and Q, the output of the summer being connected to the third terminal of the coupler 2 so that the modulated signals I and Q are emitted by the antenna 12.

The movement sensors can also be of the gyroscope type or can be designed to detect movements by measuring the Doppler effect on the received signal.

To modulate the signals in quadrature I and Q at frequency 2F, the measurement signals emitted from the movement sensors 8 are, for example, periodic square signals whose cyclic factor varies as a function of the measured acceleration, this cyclic factor being, for example, equal to 50% in the absence of acceleration and varying from + or −10% per g of acceleration, along the acceleration direction applied to the control device 1.

The fact of using a carrier frequency 2F for transmission of measurements equal to double the frequency F received, makes it possible to avoid Larsen effects.

The control device 1 is fed by a supply current comprising an autonomous continuous voltage source 10. Advantageously, the supply voltage is applied to the different components of the control device through the intermediary of a supply control circuit 9 receiving as input a detection signal sent by the detection circuit 3. In this way, the control device 1 is active only when it receives the activation signal emitted by the processing device 20. One can envisage inserting a condenser 11 in the supply control circuit 9, making it possible to maintain the supply voltage for a certain time period after the end of reception of the activation signal.

As a result of these settings, the control device 1 has low electrical consumption. It can therefore be supplied by a small sized battery and still have high autonomy.

In FIG. 2b, the processing device 20 comprises:

a generator 26 for the activation signal at frequency F, this circuit being coupled to a transmitter antenna 36 and connected to a frequency doubler in quadrature 27 supplying two reference signals I and Q at frequency 2F in phase and in phase quadrature respectively;

two receiver antennas 34, 35, preferably separated from each other, to receive the signals emitted by the control device 1, these antennas being connected to a band-pass filter 32, 33 respectively, centered on the frequency 2F;

two synchronous demodulators 28, 29 receiving an input reference signal I at frequency 2F emitted by the doubler in quadrature 27 and respectively the output signals from the filters 32, 33 and delivering output signals of acceleration measurement along the axis Y

two synchronous demodulators 30, 31 receiving an input reference signal Q at frequency 2F emitted by the doubler in quadrature 27 and respectively the signals from the filters 32, 33 and delivering output signals of acceleration measurement along the axis Z;

four samplers 22 to 25 to sample the acceleration measurement signals emitted respectively by the four demodulators 28 to 31, and

a processor 21, for example of the microprocessor type, for treating the sampled measurement signals emitted by the samplers 22 to 25, and thus defining a command to be applied to the apparatus being controlled 40, and to command the generator 26 to trigger emission of the activation signal periodically.

The processor 21 is programmed to trigger the emission of the activation signal over a time length corresponding to the period necessary for the accelerometers to provide a measurement, and with adequate periodicity, taking into account the speed of variation of the acceleration likely to be measured.

The link between the control device 1 and the processing device 20 can be a radio link. In this case, the reference frequency F of the activation signal is preferably chosen within the interval between 400 MHz and 800 MHz, for example equal to 433 MHz.

It can also be provided a switch 13 in series with the continuous voltage source 10 of the control device 1, that can be activated by the user to control the powering of the device.

The control system described just above acts in the following way.

The processor 21 of the processing device 20 controls the generator such that it transmits periodically an activation signal (at frequency F) for a time period of, for example, of the order of 5 min.

Detection of this activation signal picked up by the antenna 12, by the detection circuit 3 of the control device 1, triggers application of the supply 10 to the control device components for a time period of about 5 minutes, fixed by the value of the condenser 11. Furthermore, the received signal is filtered by the detector then processed by the doubler in quadrature 5 which provides the two sinusoidal signals in quadrature I and Q at frequency 2F. In the modulators 6 and 7, the square signals I and Q delivered by the accelerometer 8 modulate, for example in phase, the signals I and Q used as carriers. The modulated signals are then summed and amplified by the circuit summer amplifier 2, then applied as input for coupler 2 to be emitted by the antenna 12.

The modulated frequencies, summed at frequency F, are received by antennas 34 and 35 of the processing device 20. In parallel, the signal at frequency F generated by the generator 26 is processed by the doubler in quadrature 27 which generates reference signals in quadrature I and Q at frequency 2F. These signals are used to demodulate in synchronous manner the signals received by antennas 34 and 35 and filtered respectively by filters 32, 33. This demodulation carried out by the four demodulators 28 to 31 makes it possible to obtain four signals Y_{D}, Y_{G}, Z_{D}, Z_{G}, which are sampled and applied as input to the processor 21.

The command defined by processor 21 can comprise information about displacement in the XY plane and command activation information as a function of the acceleration measured along the horizontal axis Z.

The displacement information along the vertical axis Y is obtained from one of the signals sampled, Y_{G} or Y_{D}, where the weightless value g has been removed and by making a double integration of the value of the resulting acceleration. The displacement information along an axis X parallel to the axis passing the two antennas 34, 35, and preferably horizontal and parallel to the display screen 41, is obtained from the phase shift that the processor 21 can measure between the sampled signals Y_{G} and Y_{D}, or Z_{G} and Z_{D}

The command activation information is, for example, binary information obtained by comparison with an acceleration threshold measured along axis Z. In this way, the user can trigger the activation of a control by applying a movement simulating a pressure movement to the control device 1 on a control key.

Processing of acceleration information is thus carried out by the processing device 20 that is fixed and connected to the apparatus being controlled. As a result the control device 1 comprises a small number of components (no microprocessor). It can thus be integrated into a small-dimensioned box, for example in the shape of a thimble, or a ring, that can be slipped onto a user's finger with which the user simulates displacement and control movements. In this case, the switch 13 can advantageously be set inside the thimble so as to be in a closed position only when the user inserts a finger.

FIGS. 3a and 3b represent a second preferred embodiment of the control device and the processing device of the control system according to the invention. In these figures, acceleration measurements along axes Y and Z are transmitted between the control device 1a and the processing device 20a in the form of light signals, for example in the infrared field, whereas the bi-directional radio link between these two devices is preserved both for transmission of the activation signal from the control device 1a and for determining a displacement along a third axis X by measuring the phase shift of the signals produced by the control device and received by two antennas set along axis X.

In FIG. 3a, the control device comprises two light emitters 41, 42, for example electro-luminescent diodes, receiving respectively the signals for acceleration measurement along the Y and Z axes delivered by the accelerometer 8. Compared to the control device 1 shown in FIG. 2a, the device 1a thus comprises a simplified activation circuit including a single frequency doubler 45, connected to the output of the signal detector 3 tuned to the frequency F of the activation signal, and an amplifier 44 connected to the output of the doubler 45 to amplify the signal at frequency 2F produced by the doubler and to apply it to the input of the coupler 2 so that it is emitted by the antenna 12.

The emission wavelengths of the two emitters 41, 42, are different, such that they can be received separately by the processing device.

The control device 1a shown in FIG. 3a is adapted to the processing device 20a shown in FIG. 3b. This processing device comprises two light signal receivers 51, 52, adapted for detecting the signals emitted respectively by emitters 41 and 42, these receivers being for example light detection diodes sensitive in the respective wavelength ranges transmitted by emitters 41, 42.

The processing device 20a also has simplified architecture compared to that described with reference to FIG. 2b. In fact, it comprises a single frequency doubler 53 linked to the output of the frequency generator 26 for generating a reference signal at frequency 2F, two synchronous demodulators 28, 29 (instead of four) receiving as input the reference signal at frequency 2F provided as output from the doubler 53 for demodulating the signals received by the antennas 34, 35, and filtered by filters 32, 33, two samplers 22, 25 (instead of four) for sampling respectively the demodulated signals from the demodulators, the outputs of the demodulators being linked to respective inputs of the processor 21. In this control system, the accelerations along the axes Y and Z are transmitted in the form of light signals, while information about displacement along an axis X linking two antennas 34, 35, is deduced, as in the first embodiment, from the phase shift between the radio signals received by the two antennas 34, 35, spaced along the axis X.

FIGS. 4a and 4b show a third preferred embodiment of the control device and the processing device. In these figures, the control device 1c comprises an accelerometer 81 providing acceleration measurements along a single axis Z that are transmitted to the processing device 20c in the form of light signals, for example in the infrared range, while the bidirectional radio link between these two devices is kept for both the transmission of the control device activation signal 1c and for determining a displacement along axes X and Y by measuring the phase shift of the signals sent from the control device 1c and received by two pairs of antennas of the processing device 20c, set respectively along axes X and Y.

In FIG. 4a, the control device 1c has practically the same architecture as the control device 1a shown in FIG. 3a, apart from the fact that it includes an accelerometer 81 with a single axis for measuring an acceleration along the Z axis, this measurement modulating a light signal emitted by a light emitter 82.

In FIG. 4b, the processing device 20c comprises four directive antennas 84 to 87, for example of the loop type, set respectively along the axes X and Y, and which are linked respectively to the demodulators 28 to 31, possibly through the intermediary of respective band pass filters 88 to 91 centered on the frequency 2F, the outputs from the demodulators being linked to the processor 21 through the intermediary of the samplers 22 to 25. In this way, the processor can determine information about displacement along the axes X and Y by determining the phase shift between the radio signals received on the one hand by the antennas 84 and 86 and on the other hand by the antennas 85 and 87.

Evidently, it is possible to use only three antennas, regrouped in two antennas pairs set respectively along the axis X and along the axis Y.

In the same way as in the embodiment shown in FIG. 3b, the processing device 20c also comprises a single frequency doubler 53, linked to the output from the frequency generator 26 for generating a reference signal emitted by the antenna 36 and applied to an input of the synchronous demodulators 28 to 31.

The processing device 20c furthermore comprises a detector 83 linked to the processor 21 so as to receive light signals related to the acceleration along the axis Z, transmitted with the aid of the emitter 82 of the control device 1c.

The acceleration measurement along axis Z can also be transmitted in the form of a radio signal as in the first embodiment of the invention shown in FIGS. 2a and 2b. In this case, the acceleration measurement along the axis Z is transmitted by modulating the signal from the frequency doubler 45 before applying it to the amplifier 44.

1. A method for remote control of an apparatus (40), using a control device (1, 1a, 1c) carried by the user, and comprising steps of:
measuring movements of the control device along at least a first axis (Z);
determining commands to be applied to the apparatus to be controlled as a function of the movement measurements of the control device, and
applying the commands to the apparatus to be controlled, characterized in that it further includes steps during which the control device (1, 1a, 1c) transmits the movement measurements and radio-electric signals to a processing device (20, 20a, 20c) connected to the apparatus' to be controlled (40), and the processing device:
receives movement measurements and radio-electric signals from the control device through at least first and second antennas (34, 35; 84, 86) spaced out along a second axis (X) non-parallel to the first axis (Z);
demodulates in synchronous manner with a reference signal (I, Q, 2F), the radio-electric signals received by the first and second antennas respectively, and
determines the commands to be applied to the apparatus to be controlled, the commands comprising displacement information along at least the second axis (X), determined as a function of demodulated signals (XD, X_{G}, Z_{D}, Z_{G}), and control activation information determined as a function of movement measurements along the first axis (Z), received from the control device.

2. The method according to claim 1, characterized in that the movement measurements along the first axis (Z), carried out by the control device (1, 1a, 1c) are measurements of acceleration of the control device along the first axis, the processing device (20, 20a, 20c) determining the control activation information by comparing the measured acceleration with at least one predefined threshold.

3. The method according to either one of claims 1 or 2, characterized in that the processing device (20c) receives the radio-electric signals emitted by the control device (1c) through at least a third antenna (85, 87), separated from the first and second antennas (84, 86) along a third axis (Y) non-parallel to the first and second axes (X, Z) and determines information about the control device (1, 1a, 1c) displacement along the third axis (Y), by measuring phase shifts (Y_{D}, Y_{G}) between the reference signal (2F) and the radio-electric signals received by the processing device through the third antenna.

4. The method according to any one of claims 1 to 3, characterized in that it further comprises a step of periodic transmission of radio-electric signals to the control device (1, 1a, 1c), the steps of measuring and transmitting movement measurements of the control device being carried out only after reception of the activation signal.

5. The method according to any one of claims 1 to 4, characterized in that it further comprises steps of:
transmitting an activation radio-electric signal having a predefined frequency to the control device (1, 1a, 1c);
doubling the frequency of the activation signal by the control device (1, 1a, 1c) for generating a carrier having a frequency twice that of the activation signal;
modulating the carrier to transmit movement measurements of the control device to the processing device (20, 20a, 20c), and
generating the reference signal (I, Q, 2F) by the processing device consisting of doubling the frequency of the activation signal.

6. The method according to any one of claims 1 to 4, characterized in that the movement measurements along the first axis (Z) are transmitted by the control device (1a, 1c) in the form of light signals.

7. A control system for remote control of an apparatus (40), the control system comprising a control device (1, 1a, 1c) carried by the user and communicating with the apparatus to be controlled, the control device comprising means for measuring its movements along at least a first axis (Z), characterized in that the control device (1, 1a, 1c) comprises means (12, 41, 82) for emitting movement measurements and radio-electric signals, the system further comprising a processing device (20, 20a, 20c) connected to the apparatus to be controlled (40) and to at least the first and second antennas (34, 35; 84, 86; 85, 87) spaced out along a second axis (X) non-parallel to the first axis (Z), and receiving the radio-electric signals emitted by the control device, the processing device comprising:
means for receiving movement measurements emitted by the control device;
means (28 to 31) for demodulating in a synchronous manner with a reference signal (I, Q, 2F), the radio-electric signals received from the control device (1, 1a, 1c) respectively through the intermediary of the first and second antennas (34, 35; 84, 86);
means (21) for defining the displacement information along at least the second axis (X) as a function of the measured phase shifts;
means (21) for defining control activation information as a function of movement measurements along the first axis (Z), received from the control device, and
means for defining commands to be applied to the apparatus to be controlled (40), from displacement and control activation information.

8. A control system according to claim 7, characterized in that the control device (1, 1a, 1c) comprises means for measuring acceleration of the control device along the first axis (Z), and for transmitting the acceleration measurements along this axis to the processing device (20, 20a, 20c), the processing device comprising means for comparing the received acceleration measurements with a predefined threshold, to determine the control activation information.

9. A control system according to either claim 7 or 8, characterized in that the processing device (20c) comprises at least one third antenna (85, 87) spaced out from said first and second antennas along a third axis (Y) non-parallel to the first and second axes (Z, X), means (29, 31) for measuring phase shifts between the signals received by the third antenna and the reference signal (I, Q, 2F), and means for determining a displacement of the control device (1c) along the third axis, as a function of phase shifts measured by phase shift measurement means (28 to 31).

10. A control system according to any one of claims 7 to 9, characterized in that the control device (1) comprises means for transmitting the movement measurement signals along at least the first axis (Z) by modulation of the radio-electric signals.

11. A control system according to any one of claims 7 to 10, characterized in that the processing device (20, 20a, 20c) comprises means (26, 36) for periodic transmission of a radio-electric signal for activating the control device (1, 1a, 1c), the control device comprising means (2, 3) for detecting reception of the activation signal, means (9) for being at least partially off-line in the absence of detection of an activation signal, and means for activating the transmission of signals to the processing device within a predetermined time period after reception of the signal from the activation signal.

12. A control system according to claim 11, characterized in that the control device (1) comprises a frequency doubler (5, 45) to which the activation signal is applied for generating a carrier having a frequency twice that of the activation signal, and means (6, 7) for modulating the carrier as a function of movement measurements along at least the first axis (Z), and means for emitting the modulated carrier in the form of radio-electric signals, the processing device comprising a frequency doubler (27, 53) for generating the reference signal (I, Q, 2F) from the activation signal.

13. A control system according to any one of claims 7 to 11, characterized in that the control device (1a, 1c) comprises means for transmitting movement measurement signals from the control device along at least the first axis (Z) in the form of light signals.

14. A control system according to any one of claims 7 to 13, characterized in that the control device comprises a switch (13) for putting it off-line.

15. A control system according to any one of claims 7 to 14, characterized in that the control device (1, 1a, 1b, 1c) has a shape such that it can be fixed over a finger of the user.

16. A control system according to claim 15, characterized in that the control device comprises a switch (13) for putting it off-line, arranged in such a way as to be on-line only when it is slipped onto a finger of the user.
